(19) United States
(12) Patent Application Publication
(10) Pub. No.: US 2023/0284647 A1
(43) Pub. Date: Sep. 14, 2023

(54) COFFEE BEAN INFUSION PROCESS

(71) Applicant: White Mountain Chaga, LLC dba Peak State, Boulder, CO (US)

(72) Inventors: Carl Andrew Bailey, Bellingham, WA (US); Daniel Thomas Walsh, Boulder, CO (US)

(21) Appl. No.: 18/119,555

(22) Filed: Mar. 9, 2023

Related U.S. Application Data
(60) Provisional application No. 63/317,962, filed on Mar. 9, 2022.

(51) Int. Cl. A23F 5/14; A23F 5/28; A23F 5/16

(52) U.S. Cl. CPC A23F 5/145; A23F 5/285; A23F 5/16

(57) ABSTRACT

This disclosure describes a method for coating coffee beans, the method comprising providing a water-ethanol solution comprising at least 20% ethanol by volume, mixing at least one ingredient with the solution, extracting one or more of micronutrients and organic compounds from the at least one ingredient into the solution to create an extract, roasting coffee beans at a temperature that is in a range from about 120 to about 375 degrees Celsius to form roasted coffee beans, cooling the roasted coffee beans to between 32 and 120 degrees Celsius, and applying the extract on an exterior surface of the roasted coffee beans while they are in this temperature range to form coated coffee beans, wherein a weight ratio of the extract to the coffee beans ranges from about 0.1% to about 40%, and wherein the applying comprises simultaneously spraying the extract on and stirring the roasted coffee beans.

### CLAIM OF PRIORITY UNDER 35 U.S.C. § 119

The present application for patent claims priority to Provisional Application No. 63/317,962 entitled “An Elevated Temperature Infusion Process for Binding Extracted Mushroom Compounds to Coffee Beans” filed Mar. 9, 2022, and assigned to the assignee hereof and hereby expressly incorporated by reference herein.

### FIELD OF THE DISCLOSURE

The present disclosure relates generally to a process for coating and infusing coffee beans. In particular, but not by way of limitation, the present disclosure relates to systems, methods and apparatuses for coated coffee beans with micronutrients extracted from one or more adaptogenic ingredients.

### DESCRIPTION OF RELATED ART

Adaptogens are active ingredients (e.g., micronutrients, organic compounds) in certain plants, mushrooms, and/or fungi that are believed to provide both a “nutritious” and “healthy” effect (i.e., the item has an effect similar to a pharmaceutical) to the person ingesting the adaptogen. Recently, mushroom extracts have been incorporated into dietary supplements and food ingredients since certain compounds (e.g., beta-glucans) from mushrooms are purported to provide an extra health benefit in addition to the basic nutritional value of the food. Due to the widespread consumption of coffee, prior commercial ventures have attempted to combine dry, powdered mushroom extract with ground coffee to help consumers incorporate mushrooms into their daily diets. However, such techniques suffer some deficiencies. For example, ground coffee may result in significant loss of flavor if not consumed within a short time frame (e.g., 30 minutes, <1 day, etc.). As such, infusing adaptogenic ingredients into ground coffee adversely impacts the consumer experience. Thus, there is a need for a refined technique for infusing whole coffee beans with adaptogenic ingredients derived from mushrooms, fungi, and/or plant sources to not only help consumers incorporate said adaptogenic ingredients into their daily diets, but also help maintain the subtle flavor profiles, aroma, and/or intensity that consumers associate with coffee.

The description provided in the Description of Related Art section should not be assumed to be prior art merely because it is included in or associated with this section. The Description of Related Art section may include one or more aspects of the subject technology.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Emerging technology in the commercial food production sector has brought about a boom in food ingredients and meals that are infused with micronutrients and/or organic compounds derived from adaptogenic ingredients (e.g., certain plants, mushrooms, and/or fungi that are purported to provide a “nutritious” and “healthy” effect). As an integral component of many daily routines, coffee is a convenient pathway to ingest said micronutrients and/or organic compounds. Current techniques for incorporating the micronutrients and/or organic compounds found in mushrooms are limited to ground coffee. However, once coffee beans are ground, they start to lose their aromatic and flavor intensity relatively quickly (e.g., <30 minutes). Additionally, certain micronutrients and organic compounds found in adaptogenic ingredients, such as mushrooms, are temperature-sensitive and prone to degradation if applied to coffee beans that are at an elevated temperature (e.g., >120 degrees Celsius, >180 degrees Fahrenheit, >250 degrees Fahrenheit, to name a few non-limiting examples). Since coffee beans are typically roasted prior to packaging, applying mushroom extract prior to the roasting step can adversely impact the efficacy of the micronutrients and organic compounds in the final product. As such, there is a need for a refined technique for infusing and coating whole coffee beans with mushroom extracts (or another extract from an adaptogenic ingredient), which not helps maintain the flavor and aromatic profile, but also the efficacy of the micronutrients and organic compounds once the coffee is brewed.

Broadly, aspects of the present disclosure are directed to a process or method for infusing roasted coffee beans with micronutrients and/or organic compounds derived from mushroom sources. In some cases, the roasted coffee beans are maintained within a pre-defined temperature range (e.g., from about 30 degrees Celsius to about 120 degrees Celsius) while they are coated with the mushroom extract, which not helps protect the micronutrients from processing damage, but also facilitates in evaporating at least a portion of the extract from the exterior surface of the coffee beans to minimize or inhibit microbial growth. In some cases, the extract is created by mixing at least one adaptogenic ingredient (e.g., mushrooms) into a solution (e.g., water-ethanol mixture, where at least 20% of the solution by volume is ethanol) such that the micronutrients and organic compounds in the mushrooms are at least one of suspended and dissolved in the solution. In some embodiments, the extract is aerosolized, misted, and/or sprayed onto roasted coffee beans while the roasted coffee beans are simultaneously agitated (e.g., stirred or mixed) to help evenly or substantially evenly spread the extract on the surface of the roasted coffee beans. In some instances, all or a majority of the water-ethanol solution evaporates from the exterior surface of the coated coffee beans leaving the micronutrients and/or organic compounds bound as precipitates to the exterior surface via intermolecular forces. In this way, the moisture content of the coated coffee beans following drying can be kept at a level (e.g., <5%, in a range from about 2% to about 3%, etc.) that minimizes or inhibits microbial growth in the coffee beans, on the surface of the coffee beans, or a combination thereof.

One aspect of the present disclosure is directed to employing the residual heat from the coffee roasting process (i.e., some of the heat retained by the roasted coffee beans) to keep the coffee oils warm and enhance their ability to mix with alcohols (e.g., the water-ethanol mixture), bind to the extracted micronutrients and organic compounds, and to use that heat to drive evaporation of the water-ethanol mixture (or solution). Having a lower boiling point than water, weaker intermolecular attraction, and low concentration in normal air, the ethanol evaporates rapidly from the elevated-temperature coffee beans. The evaporation rate of the water is slower and is proportional to the airflow rate in the environment as well as to the difference between the maximum saturation humidity ratio of air at the elevated coffee bean temperature and the humidity ratio of air in the environment. In one non-limiting example set of environmental conditions, water evaporation might occur while the ambient air temperature is much lower (e.g., 20 degrees Celsius) than that of the coffee beans and therefore able to transport moisture away from the coffee beans at either a low relative humidity (RH) (e.g., <=50%) or a high relative humidity (e.g., >>50% including and up to 99%) as the humidity ratio in air cooler than an evaporating medium is always lower than the maximum saturation humidity ratio of air at the temperature of the warmer medium. This reduces the need to do any special post-processing to evaporate the solution from the exterior surface of the coffee beans. Additionally, or alternatively, minimal to no extra energy may be needed to drive the evaporation process if the delta (or difference) in temperature is sufficiently high (e.g., 20 degrees C., 15-20 degrees C., 25 degrees C., etc.) However, it should be noted that if the temperature of the coffee beans while being coated with the extract exceeds an upper bound or threshold (e.g., 120 degrees C., 130 degrees C., etc.), the delicate organic compounds and/or micronutrients in the mushroom extract are susceptible to degradation. In one non-limiting example, water evaporation might occur while the ambient air temperature or directed drying air temperature is equal to or much higher than the temperature of the coffee beans (e.g. up to and including 130 degrees C.), given that the humidity ratio of the air is lower than the maximum saturation humidity ratio of air at the temperature of the coffee beans (e.g. drying air RH <99%). In one non-limiting example, drying the coated coffee beans comprises drying the coated coffee beans in an environment having a relative humidity that is at or below 99% and/or a temperature that is at or below 120 degrees Celsius to allow at least a portion of the extract to evaporate from the exterior surface of the coated coffee beans. In some embodiments, the coated coffee beans are dried for anywhere between 20 seconds and 60 days. In some other cases, the roasted coffee beans may be coated at a lower temperature (e.g., below 30 degrees C., below 20 degrees C.) and a lowered temperature dryer (e.g., freezer or freeze dryer) may be utilized to help drive the evaporation process. In some other cases, hot or warm air (e.g., in a temperature range from about 25 degrees C. to about 60 degrees C., or from about 50 degrees C. to about 120 degrees C.) with low to very low RH (e.g., below 20%, below 10%, etc.) can be blown over the coated coffee beans to drive the evaporation process. In some aspects, blowing hot or warm air with low RH is akin to using a blow dryer (or hair dryer) to dry wet hair. In some cases, a modified pressure atmosphere may be used to aid drying by decreasing ambient pressure at the location of the coffee beans to decrease the boiling point of the water and ethanol and therefore cause evaporation to occur at or near normal environmental temperatures (e.g., from about 20 degrees Celsius to about 25 degrees Celsius).

In some aspects, the techniques described herein relate to a method for coating coffee beans, the method including: providing a solution, wherein the solution includes water and ethanol, and wherein at least 20% of the solution by volume is ethanol; mixing at least one ingredient with the solution; extracting, based at least in part on the mixing, one or more of micronutrients and organic compounds from the at least one ingredient into the solution to create an extract; roasting coffee beans at a temperature that is in a range from about 120 degrees Celsius to about 375 degrees Celsius to form roasted coffee beans; cooling the roasted coffee beans to between 32 and 120 degrees Celsius; and applying the extract on an exterior surface of the roasted coffee beans while they are in this temperature range to form coated coffee beans, wherein a weight ratio of the extract to the coffee beans ranges from about 0.1% to about 40%, and wherein the applying includes simultaneously spraying the extract on the roasted coffee beans and stirring the roasted coffee beans.

In some embodiments, the applying comprises (1) spraying the extract while mixing or stirring the roasted coffee beans, (2) spraying the extract during short pauses in mixing, (3) misting the extract onto the roasted coffee beans and either continuously stirring the roasted coffee beans or having brief pauses between the misting and stirring, or (4) dripping the extract onto the coffee beans while stirring the coffee beans.

In some aspects, the techniques described herein relate to a method, wherein the extract is evenly or substantially evenly spread on the exterior surface of the roasted coffee beans, based at least in part on the stirring.

In some aspects, the techniques described herein relate to a method, further including: drying the coated coffee beans in an environment having a relative humidity that is at or below 99% and a temperature that is at or below 120 degrees Celsius to allow at least a portion of the extract to evaporate from the exterior surface of the coated coffee beans; and wherein the coated coffee beans are dried for between 20 seconds and 60 days.

In some aspects, the techniques described herein relate to a method, wherein the drying is configured to: allow one or more of the micronutrients and the organic compounds to remain as precipitates bound to the exterior surface of the coated coffee beans via intermolecular forces; and wherein a moisture content of the coated coffee beans following the drying is less than 5%.

In some aspects, the techniques described herein relate to a method, further including: drying the coated coffee beans in an environment that is at or below 120 degrees Celsius and having (1) a relative humidity that is at or below 60% and a temperature that is equal to or greater than the coffee bean temperature or (2) a relative humidity that is between 60% and 99% and a temperature that is less than the coffee bean temperature.

In some aspects, the techniques described herein relate to a method, wherein, during the applying: at least a portion of the extract applied on the exterior surface of the roasted coffee beans evaporates; and one or more of the micronutrients and the organic compounds bind to the exterior surface of the roasted coffee beans via intermolecular forces.

In some aspects, the techniques described herein relate to a method, wherein the at least one ingredient includes one or more of mushrooms and fungi, the one or more of mushrooms and fungi selected from a group consisting of Hydnoid fungi, Inonotus, Ganoderma, Cordycipitaceae, and Trametes.

In some aspects, the techniques described herein relate to a method, wherein the at least one ingredient includes one or more mushrooms, the one or more mushrooms selected from a group consisting of Mesima mushroom, Maitake mushroom, Shiitake mushroom, Agaricus blazei mushroom, Poria cocos mushroom, Agarikon mushroom, Suehirotake mushroom, Oyster mushroom, Tinder Polypore mushroom, Enokitake mushroom, Yellow morel mushroom, Wood ear mushroom, Lentinus mushroom, Lion's Mane mushroom, Chaga mushroom, Reishi mushroom, Cordyceps mushroom, and Turkey Tail mushroom.

In some aspects, the techniques described herein relate to a method, wherein the micronutrients include one or more of: beta-glucans, naturally occurring polysaccharides in the one or more mushrooms, riboflavin, niacin, pantothenic acid, selenium, copper, potassium, Vitamin D, fiber, and antioxidants.

In some aspects, the techniques described herein relate to a method, wherein prior to mixing the at least one ingredient with the solution, the method includes: pulverizing the at least one ingredient into a powder; and wherein the mixing the at least one ingredient includes mixing the powder into the solution.

In some aspects, the techniques described herein relate to a method, wherein the at least one ingredient includes one or more adaptogens or active ingredients present in one or more of plants and mushrooms.

In some embodiments, the at least one ingredient may include a functional ingredient and/or an adaptogenic botanical. Some non-limiting examples of adaptogenic botanicals include Ashwagandha (Withania somnifera), Holy Basil (Ocimum tenuiflorum), Turmeric (Curcuma longa), Ginseng (Panax ginseng), Rhodiola (Rhodiola rosea), American ginseng (Panax quinquefolium), Eleuthero (Eleutherococcus senticosus), Milk thistle (Silybum marianum), and/or Ginkgo (Ginkgo biloba).

In some aspects, the techniques described herein relate to a method, wherein less than 50% of the solution, by volume, is ethanol.

In some aspects, the techniques described herein relate to a method, wherein the applying is configured to inhibit microbial activity within the coated coffee beans, on the exterior surface of the coated coffee beans, or a combination thereof.

In some aspects, the techniques described herein relate to a method, wherein the at least one ingredient comprises one or more of mushrooms and fungi, the one or more of mushrooms and fungi selected from a group consisting of Conocybe, Galerina, Gymnopilus, Onocybe, Panaeolus, Pholiotina, Pluteus, and Psilocybe.

In some aspects, the techniques described herein relate to a method, wherein the at least one ingredient comprises one or more mushrooms, the one or more mushrooms selected from a group consisting of Psilocybe cubensis, Psilocybe semilanceata, Psilocybe azurescens, Psilocybe tampanensis, Psilocybe zapotecorum, Psilocybe cyanescens, Panaeolus cyanescens, Psilocybe caerulescens, Psilocybe mexicana, Psilocybe caerulipes, Psilocybe stuntzii, and Psilocybe baeocystis.

In some aspects, the techniques described herein relate to a method, wherein the micronutrients include one or more of psilocybin and psilocin.

In some aspects, the techniques described herein relate to a coffee preparation including: roasted coffee beans coated with an extract to form coated coffee beans, and wherein a weight ratio of the extract to the roasted coffee beans ranges from about 0.1% to about 40%, and wherein: the roasted coffee beans are produced by roasting coffee beans to a temperature that ranges from about 120 degrees Celsius to about 375 degrees Celsius, and subsequently cooling the roasted coffee beans to between 32 degrees Celsius and 120 degrees C.; and the extract includes one or more micronutrients and organic compounds that are at least one of suspended and dissolved in a solution, the solution including a mixture of water and ethanol, and wherein ethanol is at least 20% of the solution by volume.

In some aspects, the techniques described herein relate to a coffee preparation, wherein the one or more micronutrients and organic compounds are extracted by: pulverizing at least one adaptogenic ingredient into a powder; and mixing the powder into the solution.

In some aspects, the techniques described herein relate to a coffee preparation, wherein the one or more micronutrients and organic compounds are derived from one or more of mushrooms and fungi, the one or more of mushrooms and fungi selected from a group consisting of Hydnoid fungi, Inonotus, Ganoderma, Cordycipitaceae, and Trametes.

In some aspects, the techniques described herein relate to a coffee preparation, wherein the one or more mushrooms selected from a group consisting of Mesima mushroom, Maitake mushroom, Shiitake mushroom, Agaricus blazei mushroom, Poria cocos mushroom, Agarikon mushroom, Suehirotake mushroom, Oyster mushroom, Tinder Polypore mushroom, Enokitake mushroom, Yellow morel mushroom, Wood ear mushroom, Lentinus mushroom, Lion's Mane mushroom, Chaga mushroom, Reishi mushroom, Cordyceps mushroom, and Turkey Tail mushroom.

In some aspects, the techniques described herein relate to a coffee preparation, wherein the micronutrients include one or more of beta-glucans, naturally occurring polysaccharides in the one or more mushrooms, riboflavin, niacin, pantothenic acid, selenium, copper, potassium, Vitamin D, fiber, and antioxidants.

In some aspects, the techniques described herein relate to a coffee preparation, wherein the coated coffee beans are dried in an environment having a relative humidity that is at or below 99% and a temperature that is at or below 120 degrees Celsius for at least 20 seconds to allow at least a portion of the extract to evaporate from the exterior surface, and wherein the drying is configured to allow one or more of the micronutrients and the organic compounds to remain as precipitates bound to the exterior surface via intermolecular forces.

In some aspects, the techniques described herein relate to a coffee preparation, wherein the extract is configured to inhibit microbial activity within the coated coffee beans, on the exterior surface of the coated coffee beans, or a combination thereof.

In some aspects, the techniques described herein relate to a coffee preparation, wherein the at least one ingredient used to create the extract comprises one or more of mushrooms and fungi, the one or more of mushrooms and fungi selected from a group consisting of Conocybe, Galerina, Gymnopilus, Onocybe, Panaeolus, Pholiotina, Pluteus, and Psilocybe.

In some aspects, the techniques described herein relate to a coffee preparation, wherein the at least one ingredient comprises one or more mushrooms, the one or more mushrooms selected from a group consisting of Psilocybe cubensis, Psilocybe semilanceata, Psilocybe azurescens, Psilocybe tampanensis, Psilocybe zapotecorum, Psilocybe cyanescens, Panaeolus cyanescens, Psilocybe caerulescens, Psilocybe mexicana, Psilocybe caerulipes, Psilocybe stuntzii, and Psilocybe baeocystis.

In some aspects, the techniques described herein relate to a coffee preparation, wherein the micronutrients include one or more of psilocybin and psilocin.

In some aspects, the techniques described herein relate to a system for coating coffee beans with micronutrients derived from at least one adaptogenic ingredient, the system including: an oven for roasting coffee beans, wherein the oven is configured to roast coffee beans in a temperature range from about 120 degrees Celsius to about 375 degrees Celsius; an extractor, wherein the extractor is configured to: receive a solution, wherein the solution includes water and ethanol mixed in a ratio of at least 20% ethanol by volume; and mix the at least one adaptogenic ingredient with the solution to create an extract having the micronutrients in the solution; a cooler for cooling the roasted coffee beans to below 120 degrees Celsius; a coating unit, wherein the coating unit is configured to: simultaneously spray the extract on the roasted coffee beans and stir the roasted coffee beans to spread the extract evenly or substantially evenly on an exterior surface of the roasted coffee beans to form coated coffee beans; and wherein at least a portion of the extract sprayed on the coated coffee beans is allowed to evaporate from the exterior surface such that a moisture content of the coated coffee beans is at or below 5%.

In some aspects, the techniques described herein relate to a system for coating coffee beans with micronutrients derived from at least one adaptogenic ingredient, the system further including an extractor, wherein the extractor is configured to receive a solution, wherein the solution comprises water and ethanol mixed in a ratio of at least 20% ethanol by volume; and mix the at least one adaptogenic ingredient with the solution to create the extract having the micronutrients in the solution.

In some aspects, the techniques described herein relate to a system for coating coffee beans with micronutrients derived from at least one adaptogenic ingredient, the system further including an extractor, wherein the extractor is configured to mix a first adaptogenic ingredient with water to create a first intermediary extract, mix a second adaptogenic ingredient with ethanol to create a second intermediary extract, and create a third intermediary extract via fermentation extraction, wherein the third intermediary extract comprises a third adaptogenic ingredient.

In some aspects, the techniques described herein relate to a system for coating coffee beans with micronutrients derived from at least one adaptogenic ingredient, the system further including the extractor, wherein the extractor is configured to mix the first intermediary extract, the second intermediary extract, and the third intermediary extract to create the extract, and wherein at least 20% of the extract by volume comprises ethanol.

In some embodiments, the different intermediary extracts may be created using different extraction techniques (e.g., up to 100% water extraction, up to 100% ethanol extraction, up to 100% fermentation extraction). The different intermediary extracts can be combined to form the extract comprising at least 20% ethanol (or alcohol) by volume. In some cases, the disclosed extracts (also referred to as tincture) may also be made using glycerin (or another applicable compound). In some embodiments, the extract may comprise a mixture of water, ethanol, fermented products, and glycerin, wherein at least 20% of the extract by volume is ethanol. It should be noted that, other techniques for creating extracts are contemplated in different embodiments and the examples listed herein are not intended to be limiting.

In some embodiments, the first adaptogenic ingredient, the second adaptogenic ingredient, and the third adaptogenic ingredient may be the same or different.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 is a flowchart of a method for coating coffee beans, according to various aspects of the disclosure.

FIG. 2A is an example of a method for coating coffee beans, according to various aspects of the disclosure.

FIG. 2B is an example of a method for drying coated coffee beans prior to packaging, according to various aspects of the disclosure.

FIG. 3 is a block diagram of a system for coating coffee beans, according to various aspects of the disclosure.

FIG. 4 is a conceptual graph showing weight against time for coated coffee beans as measured during the drying process, according to various aspects of the disclosure.

FIG. 5 is a conceptual graph showing a percentage or ratio of extract remaining (by weight) against time, according to various aspects of the disclosure.

FIG. 6 is a conceptual graph showing a percentage or ratio of extract lost due to evaporation against time, according to various aspects of the disclosure.

### DETAILED DESCRIPTION

The present disclosure relates to a process for coating and infusing coffee beans. In particular, but not by way of limitation, the present disclosure relates to systems, methods and apparatuses for coated coffee beans with micronutrients extracted from one or more adaptogenic ingredients (e.g., mushrooms, plants, botanicals, and/or fungi). As used herein, the term “adaptogenic ingredient” may also be used to refer to a “functional ingredient”. For example, the terms “adaptogenic mushroom” and “functional mushroom” may be used interchangeably throughout this disclosure and may refer to a mushroom that is purported to or believed to have a beneficial effect (e.g., nutritious or healthy effect by providing certain vitamins, minerals, antioxidants, etc.). In other cases, some of the mushrooms discussed herein, such as psilocybe or psilocybin mushrooms, are currently being investigated or studied for the treatment of mental health challenges (e.g., treatment resistant depression, depression, anxiety, addiction), when used alone or in combination with psychological support.

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the architecture, functionality, and operation of possible implementations of systems and methods according to various embodiments of the present disclosure. It should also be noted that, in some alternative implementations, the steps or operations noted in the blocks may occur out of the order noted in the figures. For example, two blocks shown in succession may, in fact, be executed substantially concurrently, or the blocks may sometimes be executed in the reverse order, depending upon the functionality involved.

Emerging technology in the commercial food production sector has brought about a boom in food ingredients and meals that are infused with micronutrients and/or organic compounds derived from adaptogenic ingredients (e.g., certain plants, mushrooms, and/or fungi that are purported to provide a “nutritious” and “healthy” effect). As an integral component of many daily routines, coffee is a convenient pathway to ingest said micronutrients and/or organic compounds.

Current techniques for incorporating the micronutrients and/or organic compounds found in mushrooms are limited to ground coffee. However, once coffee beans are ground, they start to lose their aromatic and flavor intensity relatively quickly (e.g., <30 minutes). Specifically, ground coffee is readily oxidized which adversely impacts its flavor. As such, many coffee-drinkers tend to opt for whole bean coffee because it can be ground and brewed within minutes to produce an aromatic and flavorful coffee beverage.

In some circumstances, packaging equipment required to package ground coffee in an inert atmosphere environment may help prevent flavor degradation and extend shelf life. However, such packaging equipment is prohibitively expensive for small-scale coffee roasting companies. Another barrier for entry is the costly mixing equipment required to grind and mix dry extracts (e.g., mushroom extract) into ground coffee. Furthermore, some methods of infusing coffee beans in the prior art involve specialty chemicals, organic solvents, and/or acids that require expert handling and care, which further adds to the cost of the final product.

In some cases, certain micronutrients and organic compounds found in adaptogenic ingredients, such as mushrooms, are temperature-sensitive and prone to degradation if applied to coffee beans that are at an elevated temperature (e.g., >120 degrees Celsius, >180 degrees Fahrenheit, >250 degrees Fahrenheit, to name a few non-limiting examples). Since coffee beans are typically roasted prior to packaging, applying mushroom extract prior to the roasting step can adversely impact the efficacy of the micronutrients and organic compounds in the final product. Furthermore, prior art techniques for infusing coffee beans are often performed at elevated temperatures (e.g., at or above 180 degrees Fahrenheit) and/or limited to certain profiles of coffee roast (e.g., dark roast, but not light or medium roast; dark and medium roast, but not light roast or decaf, etc.), which limits the customer base for the final coffee bean product.

As such, there is a need for a refined technique for infusing and coating whole coffee beans with mushroom extracts (or another extract from an adaptogenic ingredient), which not helps maintain the flavor and aromatic profile, but also the efficacy of the micronutrients and organic compounds once the coffee is brewed.

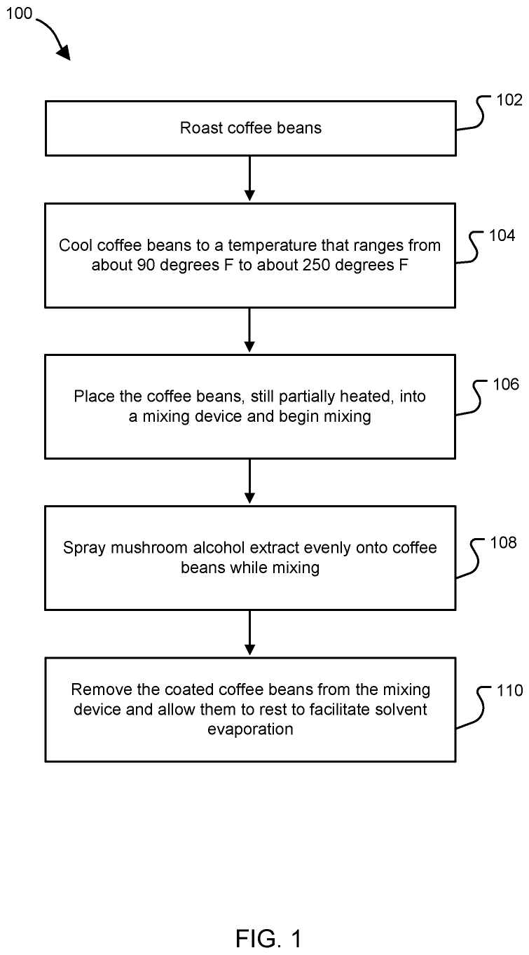

FIG. 1 illustrates a flowchart 100 of a method for coating and infusing coffee beans, according to various aspects of the disclosure. Specifically, but without limitation, flowchart 100 is directed to an elevated temperature infusion process for binding extracted mushroom compounds onto whole coffee beans.

As seen, a first operation 102 comprises roasting coffee beans to a desired profile (e.g., light roast, medium roast, dark roast, to name a few). The coffee beans may be roasted at an elevated temperature, for instance, in a range from about 250 degrees Fahrenheit to about 700 degrees Fahrenheit.

In some embodiments, a second operation 104 comprises cooling the roasted coffee beans to a temperature that ranges from about 90 degrees Fahrenheit to about 250 degrees Fahrenheit. In some cases, the roasted coffee beans may be cooled for a time period that ranges from about 10 seconds to about 20 minutes such that their temperature drops below 250 degrees Fahrenheit.

A third operation 106 comprises placing the partially heated and roasted coffee beans (e.g., in a temperature range from about 90 to about 250 degrees Fahrenheit) into a mixing device/unit.

Additionally, a fourth operation 108 comprises spraying mushroom alcohol extract onto the roasted coffee beans as they are being mixed to evenly or substantially evenly spread the extract on the exterior surface of the coffee beans to form coated coffee beans. In some cases, a weight ratio of the mushroom alcohol extract to the roasted coffee beans is in a range from about 0.1% and 40%, although other weight ratios are contemplated in different embodiments. In some cases, the weight ratio is selected to allow all or a majority of the roasted coffee beans to be evenly coated with the extract, while minimizing the amount of extract that “pools” at the bottom of the coating and mixing unit. In some embodiments, other applications besides spraying can be applied. ***

In some examples, the mushroom alcohol extract is created by extracting micronutrients and/or organic compounds from at least one adaptogenic ingredient, such as one or more mushrooms, into a solution, where the solution comprises a mixture of water and ethanol.

In one non-limiting example, at least 20% of the solution, by volume, is ethanol. For instance, the solution comprises about 20% to about 50% ethanol by volume. Other percentages (or ratios) of ethanol to water in the water-ethanol solution are contemplated in different embodiments, and the examples listed herein are not intended to be limiting. In some cases, the at least one adaptogenic ingredient comprises one or more of mushrooms and fungi, the one or more mushrooms and fungi selected from a group consisting of Hydnoid fungi, Inonotus, Ganoderma, Cordycipitaceae, and Trametes. It should be noted that, other adaptogenic ingredients can be utilized in different embodiments without departing from the scope or spirit of the disclosure. In some non-limiting examples, the one or more mushrooms are selected from a group consisting of Lion's Mane mushroom, Chaga mushroom, Reishi mushroom, Cordyceps mushroom, and Turkey Tail mushroom. Other types of mushrooms and/or plants are contemplated in different embodiments and the examples listed herein are not intended to be limiting. For example, in some cases, the one or more mushrooms may include one or more mushrooms purported to or believed to have beneficial nutritional and/or psychological properties. In some non-limiting examples, the one or more mushrooms that may be utilized include one or more of Mesima mushroom (Phellinus linteus), Maitake mushroom (Grifola frondosa), Shiitake mushroom (Lentinula edodes), Agaricus blazei mushroom (Agaricus subrufescens), Poria cocos mushroom (Wolfiporia extensa), Suehirotake mushroom (Schizophyllum commune), Oyster mushroom (Pleurotus ostreatus), Tinder Polypore mushroom (Fomes fomentarius), Lion's Mane mushroom (Hericium erinaceus), Chaga mushroom (Inonotus obliquus), Reishi mushroom (Ganoderma lingzhi), Cordyceps mushroom (Cordyceps militaris), Turkey Tail mushroom (Trametes versicolor), Enokitake mushroom (Flammulina filiformis), Yellow morel mushroom (Morchella esculenta), Wood ear mushroom (e.g., Auricularia heimuer, Auricularia cornea, and/or Tremella fuciformis), and/or Lentinus mushroom (Lentinus tigrinus). In some cases, the micronutrients include one or more beta-glucans, naturally occurring polysaccharides in the one or more mushrooms, riboflavin, niacin, pantothenic acid, selenium, copper, potassium, vitamin D, fiber, antioxidants, and any other applicable vitamins and minerals.

A fifth operation 110 comprises removing the coated coffee beans from the coating and mixing unit (or device) and allowing them to rest, which facilitates solvent evaporation and thereby inhibits or minimize microbial growth in the coated coffee beans and/or on the exterior surface of the coated coffee beans. In some cases, a majority or all of the solvent (i.e., water-ethanol solution) evaporates from the surface of the coated coffee beans, which leaves the micronutrients and organic compounds bound to the exterior surface via intermolecular forces. In some examples, the coated coffee beans are air dried in an environment with a relative humidity that is at or below a threshold (e.g., 99%, 90%, 20%, to name a few non-limiting examples) and/or a temperature that is at or below a threshold (e.g., 120 degrees Celsius, 80 degrees Celsius, to name two non-limiting examples). In other cases, the coated coffee beans are transferred to a separate drying unit, where the drying unit blows hot or warm air (e.g., in a temperature range from about 30 degrees Celsius to about 120 degrees Celsius) having low or very low humidity (e.g., <20%, <15%, etc.) to help drive the evaporation process. In other cases, the coated coffee beans may be transferred to a freezer or freeze dryer that helps evaporate the solution in the extract from the exterior surface of the coated coffee beans, thereby leaving the micronutrients and/or organic compounds bound to the exterior surface of the coated coffee beans (e.g., to the oils, lipids, or other organic molecules on the coffee beans) via intermolecular forces. In other cases, a modified pressure atmosphere may be used to aid drying by decreasing ambient pressure at the location of the coffee beans to decrease the boiling point of the water and ethanol and therefore cause evaporation to occur at or near normal environmental temperatures. The drying or evaporation process (i.e., following the coating process) is described in further detail below.

One aspect of the present disclosure is directed to employing the residual heat from the coffee roasting process (i.e., some of the heat retained by the roasted coffee beans) to keep the coffee oils warm and enhance their ability to mix with alcohols (e.g., the water-ethanol mixture), bind to the extracted micronutrients and organic compounds, and to use that heat to drive evaporation of the water-ethanol mixture (or solution). Having a lower boiling point than water, weaker intermolecular attraction, and low concentration in normal air, the ethanol evaporates rapidly from the elevated-temperature coffee beans. The evaporation rate of the water is slower and is proportional to the airflow rate in the environment as well as to the difference between the maximum saturation humidity ratio of air at the elevated coffee bean temperature and the humidity ratio of air in the environment. In one non-limiting example set of environmental conditions, water evaporation might occur while the ambient air temperature is much lower (e.g., 20 degrees Celsius) than that of the coffee beans and therefore able to transport moisture away from the coffee beans at either a low relative humidity (RH) (e.g., <=50%) or a high relative humidity (e.g., >>50% including and up to 99%) as the humidity ratio in air cooler than an evaporating medium is generally lower than the maximum saturation humidity ratio of air at the temperature of the warmer medium. This reduces the need to do any special post-processing to evaporate the solution from the exterior surface of the coffee beans. Additionally, or alternatively, minimal to no extra energy may be needed to drive the evaporation process if the delta (or difference) in temperature is sufficiently high (e.g., 20 degrees C., 15-20 degrees C., 25 degrees C., etc.) However, it should be noted that if the temperature of the coffee beans (i.e., while being coated with the extract) exceeds an upper bound or temperature threshold (e.g., 120 degrees C., 130 degrees C., etc.), the delicate organic compounds and/or micronutrients in the mushroom extract are susceptible to degradation. In one non-limiting example, water evaporation might occur while the ambient air temperature or directed drying air temperature is equal to or much higher than the temperature of the coffee beans (e.g., up to and including 130 degrees C.), given that the humidity ratio of the air is lower than the maximum saturation humidity ratio of air at the temperature of the coffee beans (e.g., drying air RH <99%). In one non-limiting example, drying the coated coffee beans comprises drying the coated coffee beans in an environment having a relative humidity that is at or below 99% and/or a temperature that is at or below 120 degrees Celsius to allow at least a portion of the extract to evaporate from the exterior surface of the coated coffee beans. In some embodiments, the coated coffee beans are dried for anywhere between 20 seconds and 60 days. In some other cases, the roasted coffee beans may be coated at a lower temperature (e.g., below 30 degrees C., below 20 degrees C.) and a lowered temperature dryer (e.g., freezer or freeze dryer) may be utilized to help drive the evaporation process. In some other cases, hot or warm air (e.g., in a temperature range from about 25 degrees C. to about 60 degrees C., or from about 50 degrees C. to about 120 degrees C.) with low to very low RH (e.g., below 20%, below 10%, etc.) can be blown over the coated coffee beans to drive the evaporation process. In some aspects, blowing hot or warm air with low RH is akin to using a blow dryer (or hair dryer) to dry wet hair. In some cases, a modified pressure atmosphere may also be used to aid drying by decreasing ambient pressure at the location of the coffee beans to decrease the boiling point of the water and ethanol and therefore cause evaporation to occur at or near normal environmental temperatures. Thus, the present disclosure allows for alternate techniques to dry/evaporate the solution from the exterior surface of the coffee beans, while ensuring that the coffee beans are evenly or substantially evenly coated with the micronutrients (e.g., derived from one or more mushrooms, plants, and/or fungi sources).

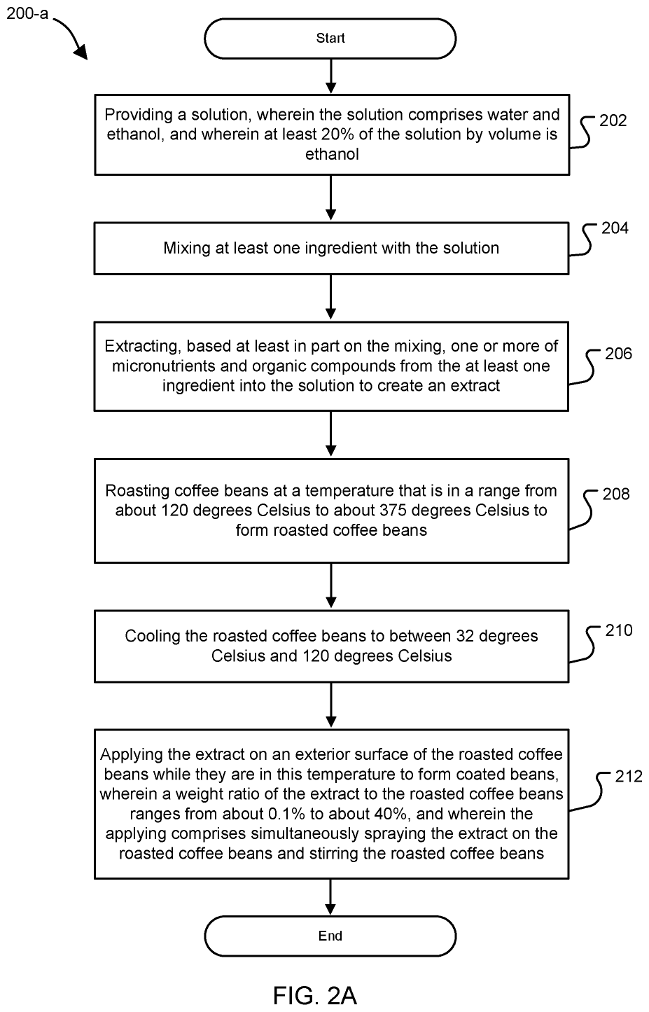

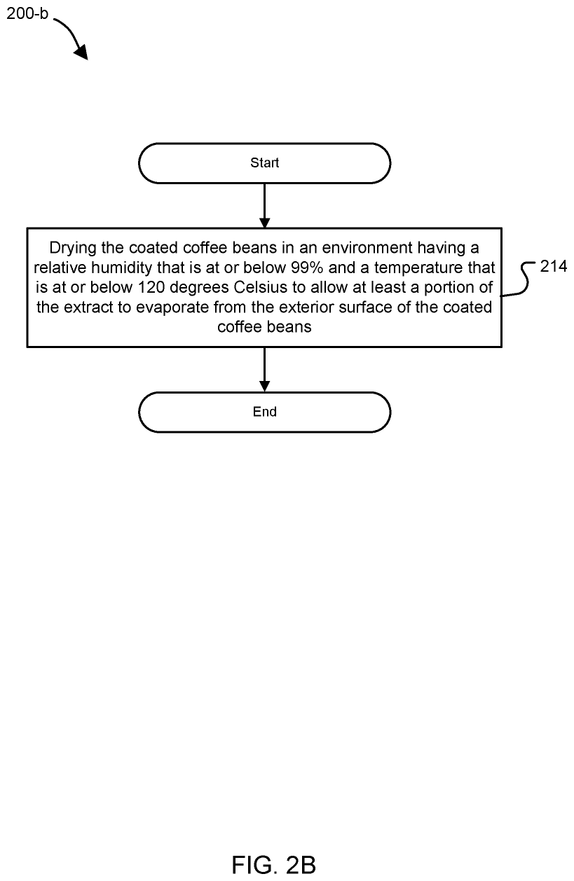

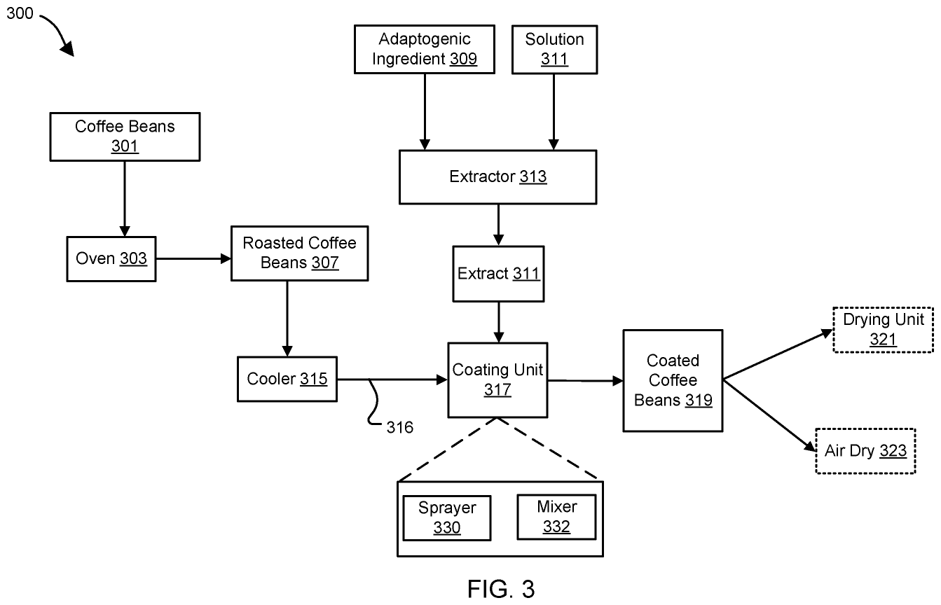

FIG. 2A illustrates another example of a method 200-a for coating coffee beans, according to various aspects of the disclosure. Method 200-a implements one or more aspects of method 100. Furthermore, methods 100 and/or 200-a may be implemented using system 300, described below in relation to FIG. 3.

A first operation 202 comprises providing a solution, wherein the solution comprises water and ethanol, and wherein at least 20% of the solution by volume is ethanol. In some examples, ethanol is less than 50% of the solution by volume, for instance, in a range from about 20% to about 50%.

A second operation 204 comprises mixing at least one ingredient (e.g., an adaptogenic ingredient, such as a plant, fungi, and/or mushroom) with the solution.

A third operation 206 comprises extracting, based at least in part on the mixing, one or more of micronutrients and organic compounds from the at least one ingredient into the solution to create an extract.

A fourth operation 208 comprises roasting the coffee beans at a temperature that is in a range from about 120 degrees Celsius to about 375 degrees Celsius to form roasted coffee beans.

A fifth operation 210 comprises cooling the roasted coffee beans to between 32 and 120 degrees Celsius. In some other cases, the roasted coffee beans may be cooled between 50 and 120 degrees Celsius.

A sixth operation 212 comprises applying the extract on an exterior surface of the roasted coffee beans while they are in this temperature range (e.g., between 32 and 120 degrees Celsius, between 50 and 120 degrees Celsius, to name two non-limiting examples) to form coated coffee beans. In some examples, a weight ratio of the extract to the roasted coffee beans ranges from about 0.1% to about 40%. In some examples, the applying comprises simultaneously spraying the extract on the roasted coffee beans and stirring the roasted coffee beans. As can be appreciated, the stirring allows the extract to spread on the exterior surface of the roasted coffee beans evenly or substantially evenly.

In some cases, at least a portion of the extract applied on the exterior surface of the roasted coffee beans evaporates during the applying process. In some cases, one or more of the micronutrients and the organic compounds bind to the exterior surface of the roasted coffee beans via intermolecular forces. The temperature range during the applying (e.g., between 32 degrees Celsius and 120 degrees Celsius, between 50 degrees Celsius and 120 degrees Celsius) is selected to optimize evaporation of the water-ethanol solution from the exterior surface, while minimizing any adverse effects on the micronutrients and/or organic compounds. As noted above, one or more of the micronutrients and/or organic compounds extracted or derived from the mushrooms may be temperature-sensitive, meaning that they can get destroyed, degraded, or lose efficacy when the temperature is above a threshold (e.g., 120 degrees Celsius, 150 degrees Celsius).

FIG. 2B illustrates an example of a method 200-b for drying coated coffee beans prior to packaging, according to various aspects of the disclosure. In some cases, the operation(s) in method 200-b may be performed following the operations in method 200-a described above in relation to FIG. 2A.

A first operation 214 comprises drying the coated coffee beans in an environment having a relative humidity that is at or below 99% and a temperature that is at or below 120 degrees Celsius to allow at least a portion of the extract to evaporate from the exterior surface of the coated coffee beans. In some embodiments, the coated coffee beans are dried for between 20 seconds and 60 days. In one non-limiting example, the coated coffee beans are dried for a time period that ranges from about 1 hour to about 6 hours.

In some cases, the drying is configured to allow one or more of the micronutrients and the organic compounds to remain as precipitates bound to the exterior surface of the coated coffee beans via intermolecular forces. In some examples, a moisture content of the coated coffee beans following drying is less than 5%, for instance, between 2-3%. This helps inhibit microbial growth on the exterior surface of the coated coffee beans and/or in the coated coffee beans.

FIG. 3 illustrates an example of a system 300 for coating coffee beans with micronutrients and/or organic compounds derived from at least one adaptogenic ingredient, according to various aspects of the disclosure.

As seen, the system 300 comprises an oven 303, where the oven is configured to receive coffee beans 301 and roast said coffee beans in a temperature range from about 120 degrees Celsius to about 375 degrees Celsius. The roasted coffee beans 307 from the oven 303 are placed in a cooler 315 (or cooling unit 315) which helps cool the roasted coffee beans to below 120 degrees Celsius.

The system 300 also comprises an extractor 313, where the extractor 313 is configured to receive at least one adaptogenic ingredient 309 (e.g., one or more mushrooms) and a solution 311. In some examples, the solution 311 comprises water and ethanol mixed in a ratio of at least 20% ethanol by volume. That is, at least 20% of the solution, by volume, comprises ethanol. The extractor 313 is configured to mix the at least one adaptogenic ingredient with the solution to create an extract 311 having the micronutrients and/or organic compounds in the solution. In some examples, the at least one adaptogenic ingredient is pulverized or crushed into a fine powder prior to mixing it into the solution 311.

In some cases, the system 300 further comprises a coating unit 317, where the coating unit 317 comprises one or more of a sprayer 330 and a mixer 332. In some cases, the coating unit 317 is configured to receive the roasted coffee beans that have been cooled to a temperature below 120 degrees Celsius, for instance, between 32 degrees C. and 120 degrees C., shown as 316. The coating unit 317 is also configured to receive the extract 311 produced by the extractor 313. In some cases, the coating unit 317 is configured to simultaneously spray the extract 311 (e.g., using the sprayer 330) and stir the roasted coffee beans (e.g., using the mixer 332). This helps spread the extract 311 evenly or substantially evenly on an exterior surface of the roasted coffee beans to form coated coffee beans 319. In some examples, the cooled and roasted coffee beans (shown as 316) may be maintained within a temperature range from about 32 and 120 degrees Celsius while in the coating unit, which facilitates in evaporation of the solution in the extract while preventing the active compounds in the mushroom extract from being denatured. In one non-limiting example, the cooler 315 may cool the roasted coffee beans to around 82 degrees Celsius (˜180 degrees Fahrenheit) prior to passing them to the coating unit 317. The coated coffee beans 319 collected from the coating unit 317 are then dried to evaporate the remainder of the solution in the extract prior to packaging. In one non-limiting example, the system 300 comprises a drying unit 321 that is configured to dry the coated coffee beans in a controlled environment, for instance, in an environment having a relative humidity that is at or below 99% and a temperature that is at or below 120 degrees Celsius, which allows at least a portion of the extract to evaporate from the exterior surface of the coated coffee beans. In some cases, the coated coffee beans are dried for between 20 seconds and 60 days, for example, in a period ranging from about 1 hour to about 6 hours. In other cases, the coated coffee beans 319 are air dried, shown by 323. In such cases, the coated coffee beans may be spread onto a flat surface (e.g., a tray) and left to air dry such that all or a majority of the solution (i.e., water-ethanol solution) evaporates from the exterior surface.

In some examples, the cooling unit (or cooler 315) may be coupled to the oven 303, or may be a part of the oven 303. That is, the cooler 315 and the oven 303 may be implemented as a single unit. In some cases, the cooler 315 is configured to blow cool air across the roasted coffee beans such that they are below the denaturing temperature of the micronutrients and/or organic compounds in the extract prior to coating. Additionally, or alternatively, the cooler 315 and the coating unit 317 may be implemented as a single unit. In some embodiments, the sprayer 330 in the coating unit 317 may be optional. For example, a user may manually spray (or mist) the roasted coffee beans with a hand-held sprayer (e.g., a spray bottle) while the mixer 332 agitates the roasted coffee beans to help ensure an even coating. In some cases, the drying unit 321 may be optional, for example, if the roasted coffee beans placed into the coating unit 317 are at a high enough temperature (e.g., between 50 and 120 degrees Celsius) to flash dry most or all of the water-ethanol solution as it contacts the exterior surface of the coffee beans. In such cases, the remainder of the water-ethanol solution can be evaporated via air drying 323.

In some cases, the disclosed system and method for coating whole coffee beans with micronutrients and/or organic compounds derived from one or more mushrooms helps maintain the aroma, flavor, and/or intensity of the coffee product, while preventing delicate (e.g., temperature-sensitive) compounds from being degraded or denatured during the hot coffee roasting process. Furthermore, the temperature range (e.g., <120 degrees Celsius, around 80-85 degrees Celsius, between 32 and 120 degrees C.) used during the coating process is selected to be high enough to facilitate evaporation of the ethanol and water solution, but prevent denaturing of the active compounds in the mushroom extract. In some aspects, mixing the coffee beans while they are still warm (but below the denaturing temperature of their active compounds) and simultaneously spraying them with the extract helps (1) evenly coat the coffee beans, and (2) evaporate the liquid (i.e., solution) in the extract at a fast enough rate to deposit the micronutrients and organic compounds on the surface of the beans. In some instances, the micronutrients and organic compounds (e.g., beta-glucans, naturally occurring polysaccharides in the one or more mushrooms, riboflavin, niacin, pantothenic acid, selenium, copper, potassium, Vitamin D, fiber, and/or antioxidants) bind to the oils, salts, and/or other molecules on the exterior surface via intermolecular forces. In some aspects, the present disclosure allows a more streamlined process as compared to the prior art since the heat from the roasting process is used to help drive the evaporation. This not only helps reduce the amount of moisture that is internally absorbed by the coffee beans, but also helps reduce the concentration of ethanol needed to inhibit microbial growth (e.g., mold). For instance, some prior art techniques utilize a high concentration of ethanol (e.g., >80-90% by volume) to reduce microbial growth. However, by minimizing the amount of time that the coffee beans are exposed to moisture (or high humidity conditions), a lower concentration (e.g., <50%) may be utilized.

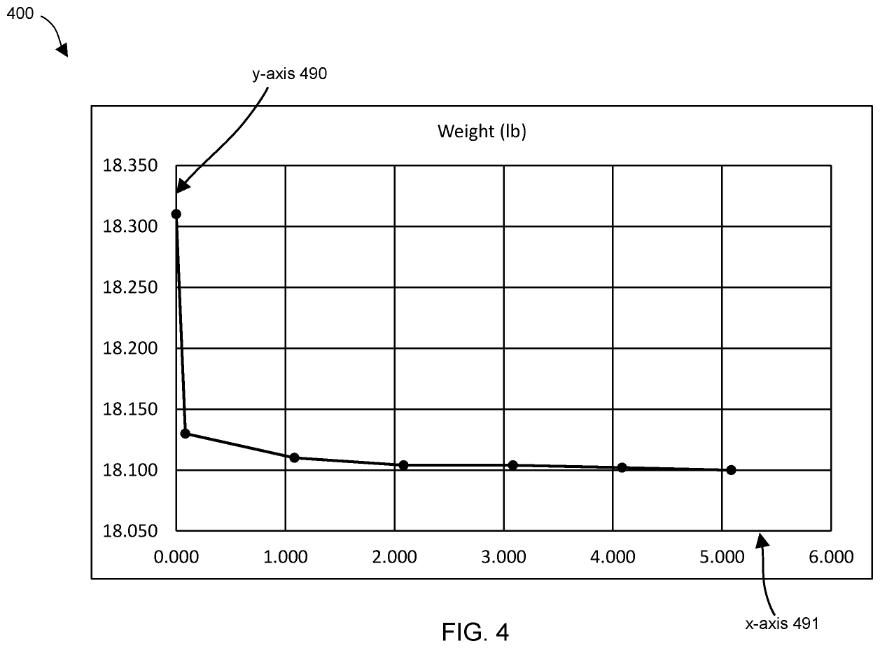

FIG. 4 is a conceptual graph 400 showing weight against time for coated coffee beans as measured during the drying process, according to various aspects of the disclosure. In this example, weight in pounds (lbs) is shown on the vertical axis (or y-axis 490), while time in hours is shown on the horizontal axis (or x-axis 491). It should be noted that, the weight and time values shown on the y-axis and x-axis, respectively, are exemplary only and not intended to be limiting. In this example, the starting weight of the coffee beans and extract is measured to be 18.310 lbs at hour 0. At 0.083 hours, the weight is measured to be around 18.130 lbs. Furthermore, the weight is 18.110 lbs at 1.083 hours, 18.104 lbs at 2.083 hours, 18.104 lbs at 3.083 hours, 18.102 lbs at 4.083 hours, and 18.100 lbs at 5.083 hours. As seen, in this example, there is rapid evaporation of the solution in the extract between 0-0.1 hours, followed by minimal decrease in the weight of the coated coffee beans after hour 1.

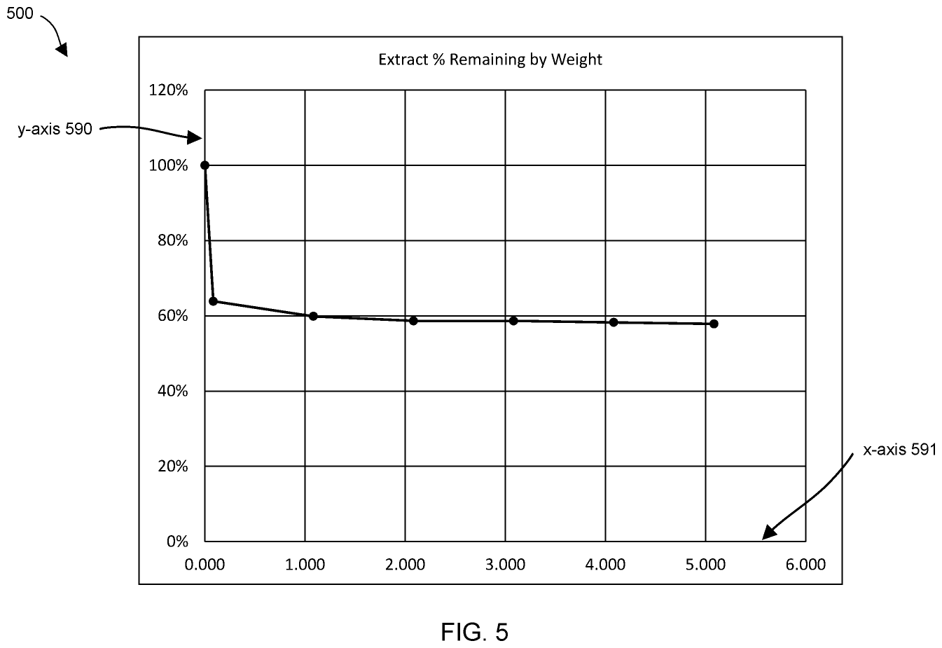

FIG. 5 is a conceptual graph 500 showing a percentage or ratio of extract remaining (by weight) against time, according to various aspects of the disclosure. The graph 500 shows percentage of extract remaining on the coated coffee beans on the vertical axis (or y-axis 590) and time (in hours) on the horizontal (or x-axis 591). As seen, at time 0, 100% of the extract sprayed on the roasted coffee beans is remaining. As a majority of the solution in the extract evaporates during the initial 0.1 hours, the percentage of extract remaining at 0.083 hours is around 64%, at 1.083 hours is around 60%, at 2.083 hours is around 59%, at 3.083 hours is around 59%, at 4.083 hours is around 58%, and at 5.083 hours is around 58%.

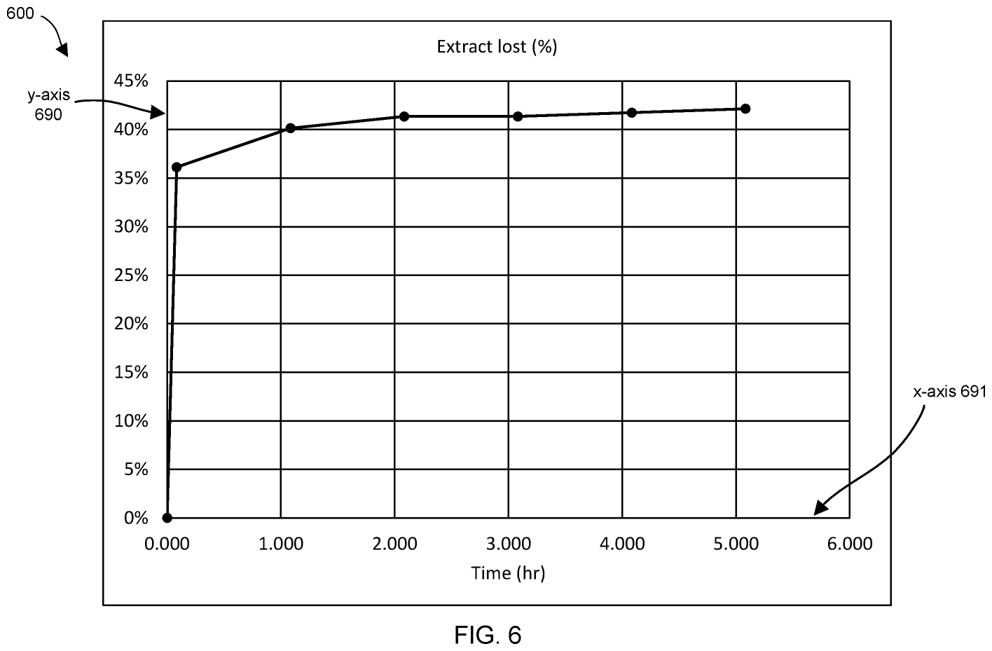

FIG. 6 is a conceptual graph 600 showing a percentage or ratio of extract lost due to evaporation against time, according to various aspects of the disclosure. The graph 600 shows percentage of extract lost (e.g., evaporated) on the vertical axis (or y-axis 690) and time (in hours) on the horizontal (or x-axis 691). Conceptual graph implements one or more aspects of graphs 400 and/or 500 described above in relation to FIGS. 5 and/or 6, respectively. In some aspects, the conceptual graph 600 is an inverse of the graph 500 since it is directed to the percentage of extract lost as opposed to the percentage of extract remaining on the coated coffee beans. As seen, at 0.083 hours, the percentage of extract lost is around 36% and at 1.083 hours is around 40%. Furthermore, at 2.083 and 3.083 hours, the percentage of extract lost is around 41%, and at 4.083 and 5.083 hours the percentage of extract lost is around 42%.

### Additional Embodiments

The present disclosure relates to a process for coating and infusing coffee beans. In particular, but not by way of limitation, the present disclosure relates to systems, methods and apparatuses for coated coffee beans with micronutrients extracted from one or more adaptogenic ingredients (e.g., mushrooms, plants, botanicals, and/or fungi). As used herein, the term “adaptogenic ingredient” may also be used to refer to a “medicinal ingredient” or “holistic ingredient” or “homeopathic ingredient”. For example, the terms “adaptogenic mushroom” and “medicinal mushroom” and “holistic mushroom” and “homeopathic mushroom” may be used interchangeably throughout this disclosure and may refer to a mushroom that is purported to or believed to have a beneficial effect relating to clinical, holistic, homeopathic, nontraditional, or naturopathic medicine (e.g., positive mental health outcome by providing certain psychoactive organic compounds, etc.).

Recent public interest has emerged in the ability of certain mushrooms to potentially assist patients with certain physical and mental health injuries, disorders, and disabilities, including but not limited to anxiety, depression, addiction, and post-traumatic stress disorder, by therapeutic use of the psychoactive compounds psilocybin (3-[2-(Dimethylamino)ethyl]-1H-indol-4-yl dihydrogen phosphate) and psilocin (4-HO-DMT). These compounds occur naturally in some genera of fungus, including but not limited to Conocybe, Galerina, Gymnopilus, Inocybe, Panaeolus, Pholiotina, Pluteus, and Psilocybe, and can be extracted using the alcohol-water extraction process disclosed herein. Furthermore, the medical arts have shown that it may be of some benefit for therapeutic use of these medicinal compounds to be conducted on a very low-dose, frequent cycle, commonly known as “microdosing”. Daily coffee intake is a common practice; therefore, coffee is an exemplary delivery vehicle for this type of therapeutic use. The extraction and infusion system described herein may be utilized to coat one or more of psilocybin and psilocin extracted from psychoactive medicinal mushrooms onto whole coffee beans.

In some aspects, the techniques described herein relate to a method, wherein the at least one ingredient includes one or more of mushrooms and fungi, the one or more of mushrooms and fungi selected from a group consisting of Conocybe, Galerina, Gymnopilus, Onocybe, Panaeolus, Pholiotina, Pluteus, and Psilocybe.

In some aspects, the techniques described herein relate to a coffee preparation, wherein the one or more mushrooms contain one or more of the substances psilocybin and psilocin, and selected from a group consisting of Psilocybe cubensis, Psilocybe semilanceata, Psilocybe azurescens, Psilocybe tampanensis, Psilocybe zapotecorum, Psilocybe cyanescens, Panaeolus cyanescens, Psilocybe caerulescens, Psilocybe mexicana, Psilocybe caerulipes, Psilocybe stuntzii, and Psilocybe baeocystis.

In some aspects, the techniques described herein relate to a coffee preparation, wherein the one or more mushrooms contain one or more of the substances psilocybin and psilocin, and selected from a group consisting of Conocybe siligineoides, Conocybe velutipes, Galerina steglichii, Gymnopilus thiersii, Gymnopilus aeruginosus, Gymnopilus braendlei, Gymnopilus cyanopalmicola, Gymnopilus dilepis, Gymnopilus dunensis, Gymnopilus intermedius, Gymnopilus lateritius, Gymnopilus luteofolius, Gymnopilus luteoviridis, Gymnopilus luteus, Gymnopilus palmicola, Gymnopilus purpuratus, Gymnopilus subpurpuratus, Gymnopilus subspectabilis, Gymnopilus validipes, Gymnopilus viridans, Panaeolus cinctulus, Panaeolus affinis, Panaeolus africanus, Panaeolus axfordii, Panaeolus bisporus, Panaeolus cambodginiensis, Panaeolus chlorocystis, Panaeolus cinctulus, Panaeolus fimicola, Panaeolus lentisporus, Panaeolus microsporus, Panaeolus moellerianus, Panaeolus olivaceus, Panaeolus rubricaulis, Panaeolus tirunelveliensis, Panaeolus tropicalis, Panaeolus venezolanus, Pholiotina cyanopus, Pholiotina smithii, Pluteus americanus, Pluteus albostipitatus, Pluteus americanus, Pluteus cyanopus, Pluteus glaucus, Pluteus glaucotinctus, Pluteus nigroviridis, Pluteus phaeocyanopus, Pluteus salicinus, Pluteus saupei, Pluteus velutinornatus, Pluteus villosus, Psilocybe atlantis, Psilocybe acutipilea, Psilocybe allenii, Psilocybe alutacea, Psilocybe angulospora, Psilocybe antioquiensis, Psilocybe araucariicola, Psilocybe atlantis, Psilocybe aquamarina, Psilocybe armandii, Psilocybe aucklandiae, Psilocybe aztecorum, Psilocybe banderillensis, Psilocybe brasiliensis, Psilocybe brunneocystidiata, Psilocybe cubensis, Psilocybe caeruleoannulata, Psilocybe callosa, Psilocybe carbonaria, Psilocybe chuxiongensis, Psilocybe collybioides, Psilocybe columbiana, Psilocybe congolensis, Psilocybe cordispora, Psilocybe cyanofibrillosa, Psilocybe dumontii, Psilocybe egonii, Psilocybe eximia, Psilocybe fagicola, Psilocybe farinacea, Psilocybe fimetaria, Psilocybe fuliginosa, Psilocybe furtadoana, Psilocybe tampanensis, Psilocybe galindoi, Psilocybe gallaeciae, Psilocybe graveolens, Psilocybe guatapensis, Psilocybe guilartensis, Psilocybe heimii, Psilocybe herrerae, Psilocybe hispanica, Psilocybe hoogshagenii, Psilocybe hopii, Psilocybe inconspicua, Psilocybe indica, Psilocybe isabelae, Psilocybe jacobsii, Psilocybe jaliscana, Psilocybe kumaenorum, Psilocybe laurae, Psilocybe lazoi, Psilocybe liniformans, Psilocybe mairei, Psilocybe makarorae, Psilocybe mammillata, Psilocybe medullosa, Psilocybe meridensis, Psilocybe meridionalis, Psilocybe mescaleroensis, Psilocybe mexicana, Psilocybe moseri, Psilocybe muliercula, Psilocybe naematoliformis, Psilocybe natalensis, Psilocybe natarajanii, Psilocybe neorhombispora, Psilocybe neoxalapensis, Psilocybe ovoideocystidiata, Psilocybe papuana, Psilocybe paulensis, Psilocybe pelliculosa, Psilocybe pintonii, Psilocybe pleurocystidiosa, Psilocybe plutonia, Psilocybe portoricensis, Psilocybe pseudoaztecorum, Psilocybe puberula, Psilocybe quebecensis, Psilocybe rickii, Psilocybe rostrata, Psilocybe rzedowskii, Psilocybe samuiensis, Psilocybe schultesii, Psilocybe septentrionalis, Psilocybe serbica, Psilocybe sierrae, Psilocybe silvatica, Psilocybe singeri, Psilocybe strictipes, Psilocybe subacutipilea, Psilocybe subaeruginascens, Psilocybe subaeruginosa, Psilocybe subbrunneocystidiata, Psilocybe subcaerulipes, Psilocybe subcubensis, Psilocybe subpsilocybioides, Psilocybe subtropicalis, Psilocybe tasmaniana, Psilocybe thaiaerugineomaculans, Psilocybe thaicordispora, Psilocybe thaiduplicatocystidiata, Psilocybe uruguayensis, Psilocybe uxpanapensis, Psilocybe venenata, Psilocybe weraroa, Psilocybe wassoniorum, Psilocybe weilii, Psilocybe weldenii, Psilocybe weraroa, Psilocybe xalapensis, Psilocybe yungensis, Psilocybe zapotecoantillarum, and Psilocybe zapotecocaribaea.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for coating coffee beans, the method comprising:
providing a solution, wherein the solution comprises water and ethanol, and wherein at least 20% of the solution by volume is ethanol;
mixing at least one ingredient with the solution;
extracting, based at least in part on the mixing, one or more of micronutrients and organic compounds from the at least one ingredient into the solution to create an extract;
roasting coffee beans at a temperature that is in a range from about 120 degrees Celsius to about 375 degrees Celsius to form roasted coffee beans;
cooling the roasted coffee beans to between 32 and 120 degrees Celsius; and
applying the extract on an exterior surface of the roasted coffee beans while they are in this temperature range to form coated coffee beans, wherein a weight ratio of the extract to the coffee beans ranges from about 0.1% to about 40%, and wherein the applying comprises simultaneously applying the extract on the roasted coffee beans and stirring the roasted coffee beans.

2. The method of claim 1, wherein the extract is evenly or substantially evenly spread on the exterior surface of the roasted coffee beans, based at least in part on the stirring.

3. The method of claim 1, further comprising:
drying the coated coffee beans in an environment having a relative humidity that is at or below 99% and a temperature that is at or below 120 degrees Celsius to allow at least a portion of the extract to evaporate from the exterior surface of the coated coffee beans; and
wherein the coated coffee beans are dried for between 20 seconds and 60 days.

4. The method of claim 3, wherein the drying is configured to:
allow one or more of the micronutrients and the organic compounds to remain as precipitates bound to the exterior surface of the coated coffee beans via intermolecular forces; and
wherein a moisture content of the coated coffee beans following the drying is less than 5%.

5. The method of claim 1, further comprising:
drying the coated coffee beans in an environment at or below 120 degrees Celsius and having (1) a relative humidity that is at or below 60% and a temperature that is equal to or greater than a temperature of the coated coffee beans or (2) a relative humidity that is between 60% and 99% and a temperature that is less than the temperature of the coated coffee beans.

6. The method of claim 1, wherein, during the applying:
at least a portion of the extract applied on the exterior surface of the roasted coffee beans evaporates; and
one or more of the micronutrients and the organic compounds bind to the exterior surface of the roasted coffee beans via intermolecular forces.

7. The method of claim 1, wherein the at least one ingredient comprises one or more of mushrooms and fungi, the one or more of mushrooms and fungi selected from a group consisting of Hydnoid fungi, Inonotus, Ganoderma, Cordycipitaceae, Trametes, Phellinus, Grifola, Lentinula, Agaricus, Wolfiporia, Schizophyllum, Pleurotus, Fomes, Hericium, Flammulina, Morchella, Auricularia, Tremella, and Lentinus.

8. The method of claim 7, wherein the micronutrients include one or more of: beta-glucans, naturally occurring polysaccharides in the one or more mushrooms, riboflavin, niacin, pantothenic acid, selenium, copper, potassium, Vitamin D, fiber, and antioxidants.

9. The method of claim 1, wherein prior to mixing the at least one ingredient with the solution, the method comprises:
pulverizing the at least one ingredient into a powder; and
wherein the mixing the at least one ingredient comprises mixing the powder into the solution.

10. The method of claim 1, wherein the at least one ingredient comprises one or more adaptogens or active ingredients present in one or more of plants and mushrooms.

11. The method of claim 1, wherein less than 50% of the solution, by volume, is ethanol.

12. The method of claim 1, wherein the applying is configured to inhibit microbial activity within the coated coffee beans, on the exterior surface of the coated coffee beans, or a combination thereof.

13. The method of claim 1, wherein the at least one ingredient comprises one or more of mushrooms and fungi, the one or more of mushrooms and fungi selected from a group consisting of Conocybe, Galerina, Gymnopilus, Onocybe, Panaeolus, Pholiotina, Pluteus, and Psilocybe.

14. The method of claim 13, wherein the at least one ingredient comprises one or more mushrooms, the one or more mushrooms selected from a group consisting of Psilocybe cubensis, Psilocybe semilanceata, Psilocybe azurescens, Psilocybe tampanensis, Psilocybe zapotecorum, Psilocybe cyanescens, Panaeolus cyanescens, Psilocybe caerulescens, Psilocybe mexicana, Psilocybe caerulipes, Psilocybe stuntzii, and Psilocybe baeocystis.

15. The method of claim 14, wherein the micronutrients include one or more of psilocybin and psilocin.

16. A coffee preparation comprising:
roasted coffee beans coated with an extract to form coated coffee beans, and wherein a weight ratio of the extract to the roasted coffee beans ranges from about 0.1% to about 40%, and wherein:
the roasted coffee beans are produced by roasting coffee beans to a temperature that ranges from about 120 degrees Celsius to about 375 degrees Celsius, and subsequently cooling the roasted coffee beans to between 32 degrees Celsius and 120 degrees C.; and
the extract comprises one or more micronutrients and organic compounds that are at least one of suspended and dissolved in a solution, the solution comprising a mixture of water and ethanol, and wherein ethanol is at least 20% of the solution by volume.

17. The coffee preparation of claim 16, wherein the one or more micronutrients and organic compounds are extracted by:
pulverizing at least one adaptogenic ingredient into a powder; and
mixing the powder into the solution.

18. The coffee preparation of claim 16, wherein the one or more micronutrients and organic compounds are derived from one or more of mushrooms and fungi, the one or more of mushrooms and fungi selected from a group consisting of Hydnoid fungi, Inonotus, Ganoderma, Cordycipitaceae, Trametes, Phellinus, Grifola, Lentinula, Agaricus, Wolfiporia, Schizophyllum, Pleurotus, Fomes, Hericium, Flammulina, Morchella, Auricularia, Tremella, and Lentinus.

19. The coffee preparation of claim 16, wherein the micronutrients include one or more of beta-glucans, naturally occurring polysaccharides in the one or more mushrooms, riboflavin, niacin, pantothenic acid, selenium, copper, potassium, Vitamin D, fiber, and antioxidants.

20. The coffee preparation of claim 16, wherein the coated coffee beans are dried in an environment having a relative humidity that is at or below 99% and a temperature that is at or below 120 degrees Celsius for at least 20 seconds to allow at least a portion of the extract to evaporate from the exterior surface, and wherein the drying is configured to allow one or more of the micronutrients and the organic compounds to remain as precipitates bound to the exterior surface via intermolecular forces.

21. The coffee preparation of claim 16, wherein the extract is configured to inhibit microbial activity within the coated coffee beans, on the exterior surface of the coated coffee beans, or a combination thereof.

22. The coffee preparation of claim 16, wherein the one or more micronutrients and organic compounds are derived from at least one ingredient, and wherein the at least one ingredient comprises one or more of mushrooms and fungi, the one or more of mushrooms and fungi selected from a group consisting of Conocybe, Galerina, Gymnopilus, Onocybe, Panaeolus, Pholiotina, Pluteus, and Psilocybe.

23. The coffee preparation of claim 22, wherein the at least one ingredient comprises one or more mushrooms, the one or more mushrooms selected from a group consisting of Psilocybe cubensis, Psilocybe semilanceata, Psilocybe azurescens, Psilocybe tampanensis, Psilocybe zapotecorum, Psilocybe cyanescens, Panaeolus cyanescens, Psilocybe caerulescens, Psilocybe mexicana, Psilocybe caerulipes, Psilocybe stuntzii, and Psilocybe baeocystis.

24. The coffee preparation of claim 23, wherein the micronutrients include one or more of psilocybin and psilocin.

25. The coffee preparation of claim 16, wherein the one or more micronutrients and organic compounds are derived from at least one ingredient, and wherein the at least one ingredient comprises one or more botanicals, and wherein the one or more botanicals are selected from a group consisting of Withania somnifera, Ocimum tenuiflorum, Curcuma longa, Panax ginseng, Rhodiola rosea, Panax quinquefolium, Eleutherococcus senticosus, Silybum marianum, and Ginkgo biloba.

26. A system for coating coffee beans with micronutrients derived from at least one adaptogenic ingredient, the system comprising:
an oven for roasting coffee beans, wherein the oven is configured to roast coffee beans in a temperature range from about 120 degrees Celsius to about 375 degrees Celsius;
a cooler for cooling the roasted coffee beans to below 120 degrees Celsius;
a coating unit, wherein the coating unit is configured to:
simultaneously apply an extract on the roasted coffee beans and stir the roasted coffee beans to spread the extract evenly or substantially evenly on an exterior surface of the roasted coffee beans to form coated coffee beans; and
wherein at least a portion of the extract applied on the coated coffee beans is allowed to evaporate from the exterior surface such that a moisture content of the coated coffee beans is at or below 5%.

27. The system of claim 26, further comprising:
an extractor, wherein the extractor is configured to:
receive a solution, wherein the solution comprises water and ethanol mixed in a ratio of at least 20% ethanol by volume; and
mix the at least one adaptogenic ingredient with the solution to create the extract having the micronutrients in the solution.

28. The system of claim 26, further comprising:
an extractor, wherein the extractor is configured to:
mix a first adaptogenic ingredient with water to create a first intermediary extract;
mix a second adaptogenic ingredient with ethanol to create a second intermediary extract; and
create a third intermediary extract via fermentation extraction, wherein the third intermediary extract comprises a third adaptogenic ingredient.

29. The system of claim 28, wherein the extractor is configured to:
mix the first intermediary extract, the second intermediary extract, and the third intermediary extract to create the extract, and wherein at least 20% of the extract by volume comprises ethanol.
